(19) United States
(12) Patent Application Publication
(10) Pub. No.: US 2007/0091268 A1
(43) Pub. Date: Apr. 26, 2007

(54) Ceiling attached mirror surface screen

(75) Inventor: Tonny Chen, Changhua (TW)

Correspondence Address: BRUCE H. TROXELL, SUITE 1404, 5205 LEESBURG PIKE, FALLS CHURCH, VA, 22041, US

(73) Assignee: E-Lead Electronic Co., Ltd.

(21) Appl. No.: 11/258,232

(22) Filed: Oct. 26, 2005

(51) Int. Cl. G03B 21/26

(52) U.S. Cl. 353/28

(57) ABSTRACT

A ceiling attached mirror surface screen to be installed on a car top of vehicles to provide displaying and mirror function for user grooming includes a base, a face panel, a screen and a transparent reflective mirror. The base has a housing recess to hold the face panel. The face panel has a housing space to hold the screen and the transparent reflective mirror. The face panel has one end hinged on the base. The transparent reflective mirror is located on the surface of the face panel. When the electric power supply is turned on, the face panel becomes a display device. When the electric power supply is turned off, the face panel becomes a mirror. Hence the same surface can be switched for displaying and user grooming.

### BACKGROUND OF THE INVENTION

1. Field of the Invention

The present invention relates to a ceiling attached mirror surface screen and particularly to ceiling attached mirror surface screen for installing on a vehicle to perform displaying and function as a mirror for user grooming.

2. Description of the Prior Art

The conventional ceiling attached multimedia display device installed on car tops mainly aims to provide recreation and entertainment for passengers. To enhance use function, TAIWAN, R.O.C. patent publication No. M255812 discloses a ceiling fastening apparatus which has a hanging board containing a mirror surface to enable people to do grooming. The hanging board is hinged on a top seat, and has a LCD on one side and a mirror surface one another side. There is a hinge mechanism between the hanging board and the top seat to unfold the hanging board and swivel the hanging board after opened. Hence the passengers can swivel the hanging board to select the LCD or mirror surface according to requirements. Such a structure is not convenient when in use. The hanging board has to be swiveled frequently to perform the desired functions. The structure is complicated and easily damaged. TAIWAN, R.O.C. patent publication No. 549262 discloses a rearview mirror for vehicles with a hidden LCD. It has a LCD installed on the backside of a reflective mirror. When the LCD is activated, it can provide driving information for the driver. However, it mainly aims for the rear view function and focuses mainly for safety purpose, and is dedicated for the driver. It does not provide recreational or viewing function for the passengers in the car. Moreover, the rearview mirror has a small size and is spaced from the rear seat at a long distance. It cannot provide playing function for entertaining purpose. Hence such a technique cannot be transferred to the ceiling attached multimedia display device. Moreover, the rearview mirror is small and cannot be used for people in the vehicle to do grooming as desired.

### SUMMARY OF THE INVENTION

In view of the aforesaid disadvantages, the present invention aims to provide an improved ceiling attached mirror surface screen that can function as a display screen and enable users to do grooming.

The ceiling attached mirror surface screen according to the invention includes a base, a face panel, a screen and a transparent reflective mirror. The base has a housing recess to hold the face panel. The face panel has a housing space to hold the screen and the transparent reflective mirror. The face panel has one end hinged on the base so that the face panel can be swiveled relative to the base for a selected angle for unfolding or folding. The transparent reflective mirror is located on the surface of the face panel. When the electric power supply is turned on, the face panel becomes a display device. When the electric power supply is turned off, the face panel becomes a mirror surface. Hence the same surface can be switched for displaying and user grooming.

In one aspect of the invention, the transparent reflective mirror is located on a upper surface of the face panel.

In another aspect of the invention, the transparent reflective mirror is located on a lower surface of the face panel.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is a perspective view of the invention in an assembled condition.

FIG. 3 is a schematic view of the invention in an operating condition.

FIG. 4 is a fragmentary sectional view of the invention in a folding and latched condition.

FIG. 5 is an exploded view of a first embodiment of the invention.

FIG. 6 is a perspective view of the first embodiment of the invention.

FIG. 7 is a schematic view of the first embodiment of the invention in an operating condition.

FIG. 8 is a schematic view of a second embodiment of the invention.

### DESCRIPTION OF THE PREFERRED EMBODIMENTS

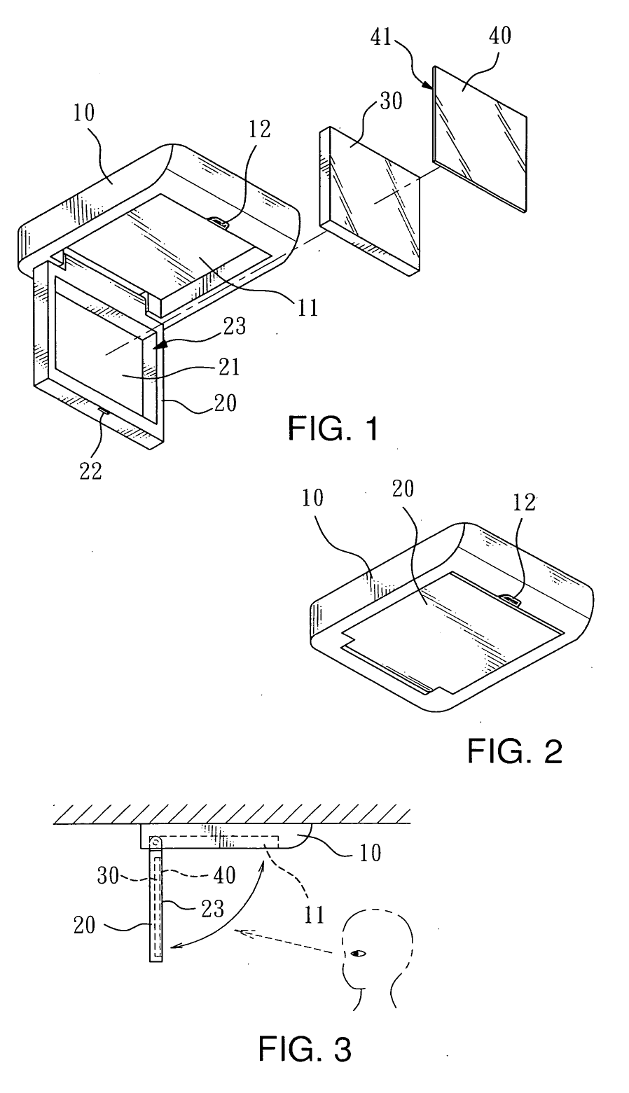

Referring to FIGS. 1 through 4, the invention includes a base 10, a face panel 20, a transparent reflective mirror 40 and a screen 30.

The base 10 is fixedly installed on an interior side of a car top, and has a housing recess 11 which has a button 12 and a latch tongue 13 on one side.

The face panel 20 is hinged on another side of the housing recess 11, and can be swiveled relative to the base 10 for a selected angle. The face panel 20 may also be folded and held in the housing recess 11 by latching of a latch trough 22 formed on an outer edge thereof with the latch tongue 13. The face panel 20 has a housing space 21.

The transparent reflective mirror 40 is located on a upper surface 23 of the housing space 21 of the face panel 20, and has a back surface corresponding to the screen 30. The front surface can function as a mirror for user grooming.

The screen 30 is located on a back side 41 of the transparent reflective mirror 40. When the screen 30 is unfolded, the picture on the screen may be seen through the transparent reflective mirror 40. When the screen 30 is not in use, it is hidden and cannot be seen.

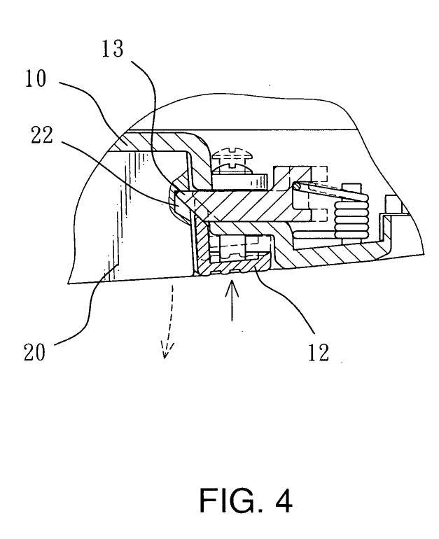

By means of the construction set forth above, when the screen 30 is unfolded, it becomes a multimedia playing device. Information received by the screen 30 can pass through the transparent reflective mirror 40 to be seen by passengers. And it can provide recreational and entertaining functions. When the screen 30 is folded, it becomes a mirror surface to reflect images for user grooming. It can be switched to function by merely turning on or off the electric power supply without moving any element. Operation is easy. The switch can be done frequently without damaging elements. When the invention is not in use, the face panel 20 may be swiveled upwards and held in the housing recess 11 of the base 10 (as shown in FIG. 4). The latch trough 22 on the outer edge of the face panel 20 can be engaged with the latch tongue 12 to form a folding condition without occupying a lot of space. When in use, depress the button 12 to move the latch tongue 13 away from the latch trough 22, then the face panel 20 can be swiveled downwards in a use condition.

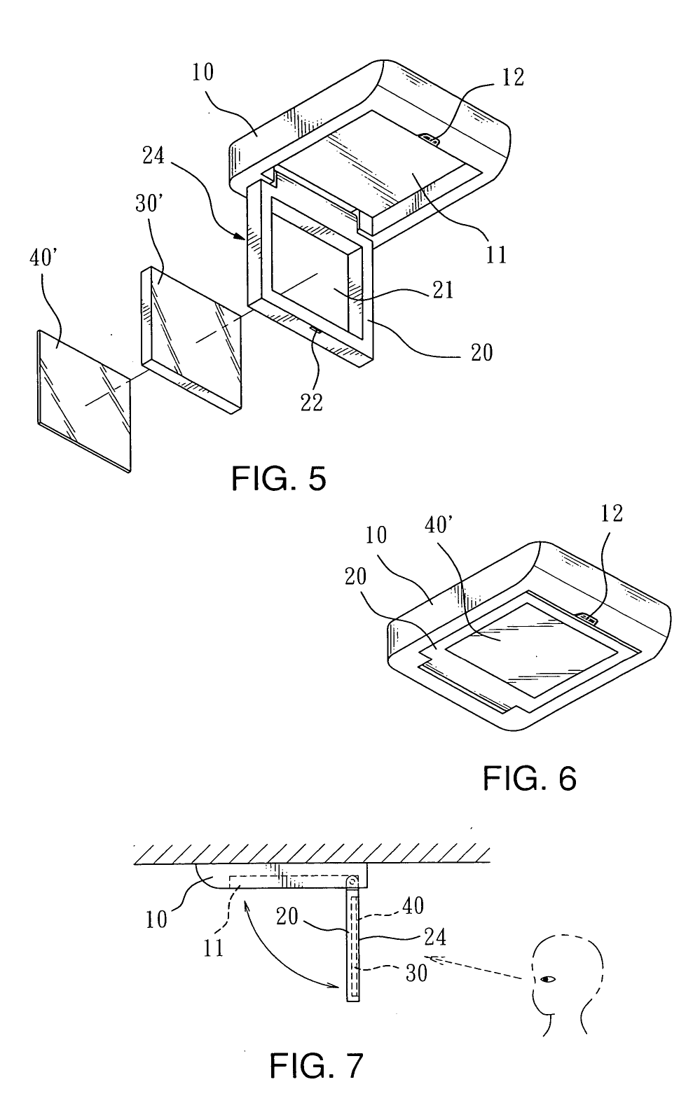

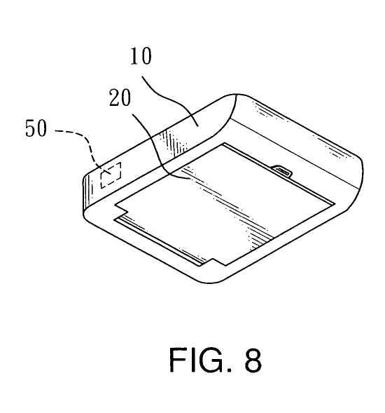

Referring to FIGS. 5, 6 and 7, the direction of the display surface may be altered according to use conditions. After the screen 30′ is held in the housing space 21 of the face panel 20, the transparent reflective mirror 40′ may be located on a lower surface 24 of the face panel 20. Operation is same as those previously discussed.

Referring to FIG. 8, the invention may further include an expansion unit 50 which may be a USB interface or a Bluetooth interface to receive and transmit data.

In summary, the invention is easy to operate and use, and can overcome the problems occurred to the conventional techniques.

I claim:

1. A ceiling attached mirror surface screen comprising a base, a face panel, a transparent reflective mirror and a screen, wherein:
the base is fixedly installed on a ceiling and has a housing recess;
the face panel is hinged on one side of the housing recess and swivelable up and down relative to the base, and foldable to be held in the housing recess, and has a housing space;
the transparent reflective mirror is located on a surface of the housing space, and has a back surface corresponding to the screen, and a front surface to function as a mirror surface for user grooming; and
the screen is located on a back side of the transparent reflective mirror to display pictures through the transparent reflective mirror when unfolded, and hidden when not in use;
wherein the ceiling attached mirror surface screen functions as a playing device when an electric power supply is turned on, and a mirror surface for user grooming when the electric power supply is turned off.

2. The ceiling attached mirror surface screen of claim 1, wherein the transparent reflective mirror is located on a upper surface of the face panel.

3. The ceiling attached mirror surface screen of claim 1, wherein the transparent reflective mirror is located on a lower surface of the face panel.

4. The ceiling attached mirror surface screen of claim 1, wherein the base has a button and a latch tongue to control unfolding and folding of the face panel.

5. The ceiling attached mirror surface screen of claim 4, wherein the face panel further includes a latch trough to engage with the latch tongue.

6. The ceiling attached mirror surface screen of claim 1, wherein the base has an expansion unit.

7. The ceiling attached mirror surface screen of claim 6, wherein the expansion unit is a USB interface to read a memory card.

8. The ceiling attached mirror surface screen of claim 6, wherein the expansion unit is a Bluetooth interface to receive and transmit data.
